(19) United States
(12) Patent Application Publication
(10) Pub. No.: US 2006/0279099 A1
(43) Pub. Date: Dec. 14, 2006

(54) Cargo management system and apparatus

(76) Inventors: Noel v. Ranka, Canton, MI (US); Donald R. Potter, Clarkston, MI (US); Donald L. Munoz, Bloomfield Hills, MI (US); Gerard J. Kmita, Allen Park, MI (US); Milton J. Antonick, Royal Oak, MI (US)

Correspondence Address: HARNESS, DICKEY & PIERCE, P.L.C., P.O. BOX 828, BLOOMFIELD HILLS, MI, 48303, US

(21) Appl. No.: 11/450,958

(22) Filed: Jun. 9, 2006

Related U.S. Application Data
(60) Provisional application No. 60/689,665, filed on Jun. 10, 2005.

(51) Int. Cl. B60R 9/06

(52) U.S. Cl. 296/37.6

(57) ABSTRACT

A cargo management system for use in a bed of a pickup truck. The cargo management system includes a pair of frame assemblies that are supported from siderails secured to the inside walls of the pickup truck bed. Each of the frame assemblies is capable of receiving two removable cargo bins that can be used to hold various smaller cargo items. The frame assemblies each have a pair of horizontally disposed tracks for supporting a slidably moveable support platform. The support platform can be positioned in either a lower pair of the tracks or an upper pair of the tracks as needed. Each of the frame assemblies can be quickly removed from the pickup truck bed if needed to maximize the available area within the bed for large cargo items.

### CROSS-REFERENCE TO RELATED APPLICATIONS

The present application claims priority from U.S. provisional 60/689,665 filed Jun. 10, 2005, the disclosure of the above applications are incorporated herein by reference.

### FIELD

The present disclosure relates to cargo management systems, and more particularly to a cargo management system adapted for use in a pickup truck bed for securing cargo and various types of articles against movement while the vehicle is in use.

### BACKGROUND

Cargo management systems used with motor vehicles, and particularly with pickup trucks, are becoming more and more desirable, as pickup trucks gain in popularity.

While various forms of cargo management systems have been employed, there still remains a need for a cargo management system that provides a means for containing articles such as groceries and other lightweight items, and which still can be placed in a storage mode to make the great majority of the pickup bed available for use for carrying larger items, without complicated or burdensome disassembly operations, and without requiring removal of all or part of the apparatus from the pickup bed. There also remains a need for such a cargo management system that can be moved and adjustably positioned within the bed of a pickup truck to act as a bulkhead to effectively partition the bed to assist in restraining larger items.

### SUMMARY

The present disclosure relates to a cargo management system especially well adapted for use in a bed of a pickup truck. In one exemplary embodiment a cargo management system is shown that enables a plurality of storage containers to be supported adjacent the sidewalls of a pickup truck bed. The containers are supported with a pair of frame assemblies that are each associated with a respective sidewall of the bed. The frame assemblies are positioned on siderails so that they extend along each of the pickup bed sidewalls and do not interfere with the major area of the bed. The containers are easily removed from the frame assemblies, and can also be locked to their respective frame assembly. The frame assemblies also provide two pairs of support tracks that can be used to support a planar support panel above the floor of the bed. The support panel can be supported at a first elevated level or at a second (i.e., lower) level above the floor of the bed. An alternative embodiment is presented in which the frame assemblies can be used as supports for a plurality of cross bars to form a surface elevated above the truck bed sidewalls on which articles can be supported, thus freeing up significant space within the truck bed for other cargo items.

Further areas of applicability of the present disclosure will become apparent from the detailed description provided hereinafter. It should be understood that the detailed description and specific examples, while indicating various embodiments, are intended for purposes of illustration only and are not intended to limit the scope of the present disclosure.

### BRIEF DESCRIPTION OF THE DRAWINGS

The present disclosure will become more fully understood from the detailed description and the accompanying drawings, wherein:

FIG. 1 is a perspective view of an exemplary embodiment of the cargo management system of the present disclosure;

FIG. 2 is a perspective view of the cargo management system of FIG. 8 removed from the bed of a pickup truck to more clearly illustrate the various components thereof;

FIG. 3 is an enlarged perspective view of a first frame assembly of the system of FIG. 2;

FIG. 4A is an end view of one of the rails used with the frame assemblies;

FIG. 4B is a front view of the rail shown in FIG. 4A taken along directional arrow 4B;

FIG. 5 is an exploded perspective view of the components comprising the first frame assembly, as well as representative portions of the siderails which are mounted to the walls of the truck bed, and a portion of a slidably supported load platform;

FIG. 6 is an enlarged perspective view of the center attaching portion of the frame assembly of FIG. 5;

FIG. 7 is an enlarged perspective view of the end attaching portion of the frame assembly of FIG. 5;

FIG. 8 is a bottom perspective view of the center attaching portion of the frame assembly of FIG. 5 illustrating the locking knobs used to retain the frame assembly to the siderail;

FIG. 9 is an exploded perspective view of the components comprising the end portion of the frame assembly;

FIGS. 10a-10d are various views of the locking pivot cap used with the frame assembly;

FIGS. 11a-11e are various views of the locking element used with the component of FIG. 9;

FIG. 12a-12d are various views of the center slider used with the frame assembly of FIG. 5;

FIGS. 13a-13d illustrate various views of the central frame element used with the frame assembly of FIG. 5;

FIGS. 14a-14d are various views of the end frame element; and

FIG. 15 is a rear view of a pickup truck with an alternative preferred implementation of the present invention in which the frame assemblies are rotated up to a point above the sidewalls of the truck bed and secured rigidly with a cross member, to thus form an elevated platform on which articles may be supported.

### DETAILED DESCRIPTION

The following description of the various embodiment(s) is merely exemplary in nature and is in no way intended to limit the present disclosure, its application, or uses.

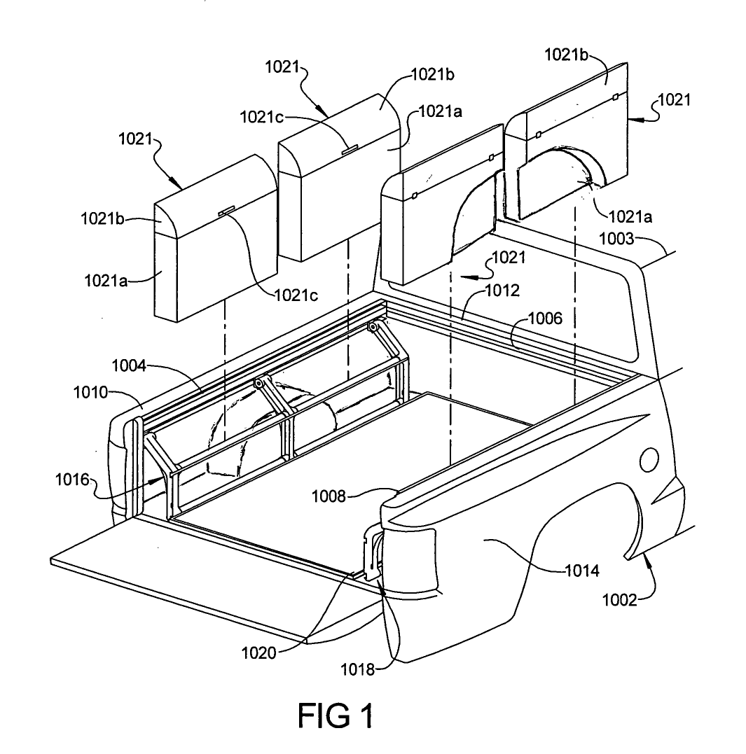

Referring to FIG. 1, there is shown an alternative preferred cargo management system 1000 of the present invention disposed within a pickup truck bed 1002 of a pickup truck 1003. Cargo management system 1000 incorporates a plurality of siderails 1004, 1006 and 1008 that are secured to bed sidewalls 1010, 1012 and 1014 respectively.

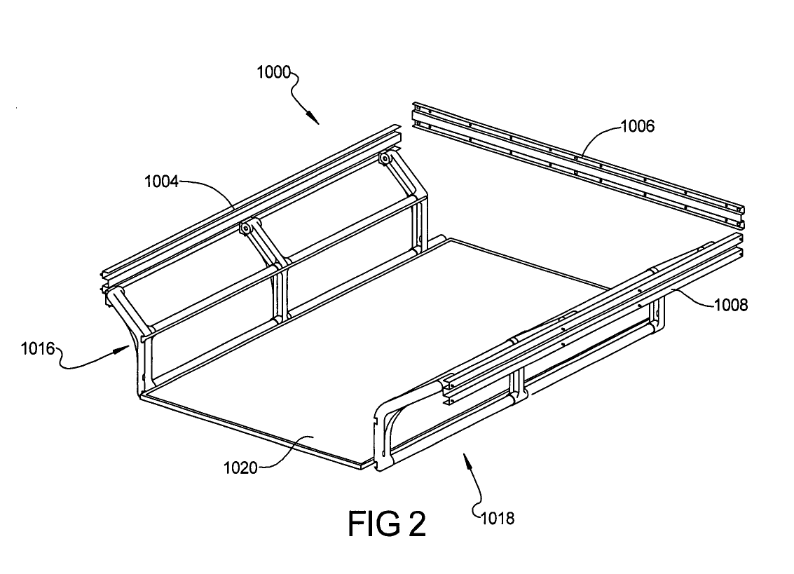

Referring to FIGS. 1 and 2, the cargo management assembly 1000 includes a first frame assembly 1016 and a second frame assembly 1018. A support platform in the form of a planar element 1020 is slidably supported from the frame assemblies 1016 and 1018. The frame assembly 1016 is releasably secured to siderail 1004, while second frame assembly 1018 is releasably secured to siderail 1008. The planar support panel 1020 can be slidably supported at either of two levels by the frame assemblies 1016, 1018, as will be further explained in the following paragraphs, and may be constructed from high strength plastic, aluminum, steel or any other material having suitable strength and rigidity.

With further reference to FIG. 1, each one of the frame assemblies 1016 and 1018 releasably support a pair of cargo bins 1021 in an upright orientation. Each of cargo bins 1021 includes a main body 1021a and cover 1021b. Cover 1021b is pivotally secured to the main body 1021a. Each cargo bin 1021 preferably includes a locking structure 1021c to permit each to be locked via a key or combination lock structure. Once opened, separate engaging structure (not shown) associated with the cargo bin 1021 and the frame assembly (1016 or 1018) can be implemented to enable the cargo bin to be released from its associated frame assembly so that the cargo bin can be entirely removed from its frame assembly. Thus, removal of the cargo bins 1021 can only be accomplished from accessing the inside of the cargo bin. Cargo bins 1021 are preferably formed from high strength plastic or another suitably strong, lightweight, weather resistant material. While the cargo bins 1021 are all illustrated as being the same size and shape, it will be appreciated that the frame assemblies 1016, 1018 could be modified to provide two compartments that are of different dimensions, to thus allow cargo bins of different sizes to be used on each frame assembly 1016, 1018.

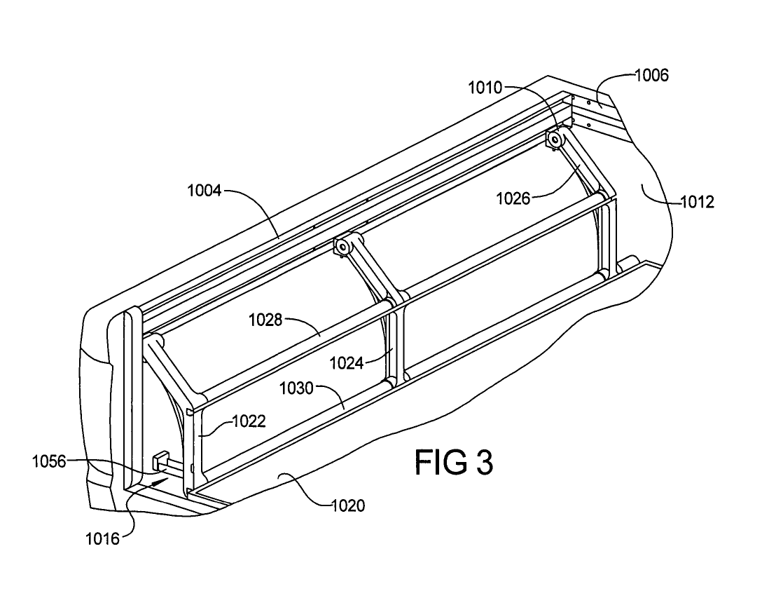

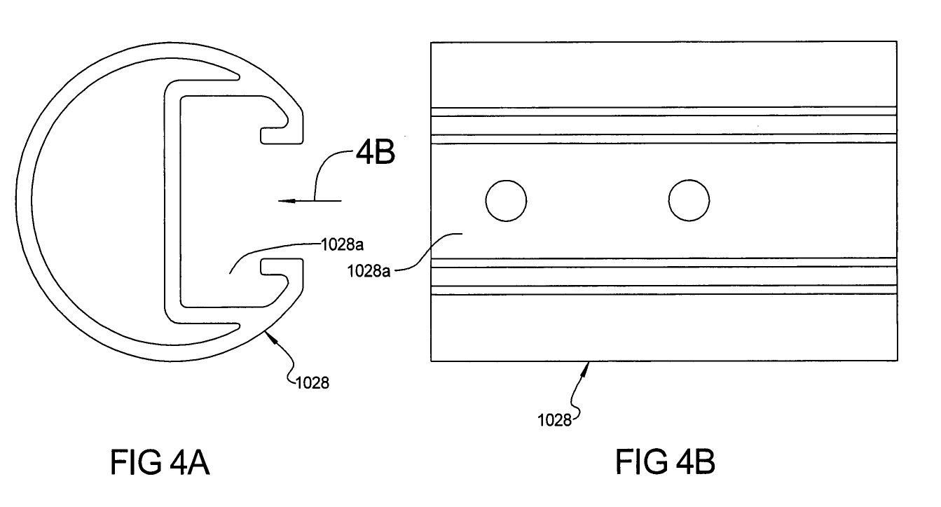

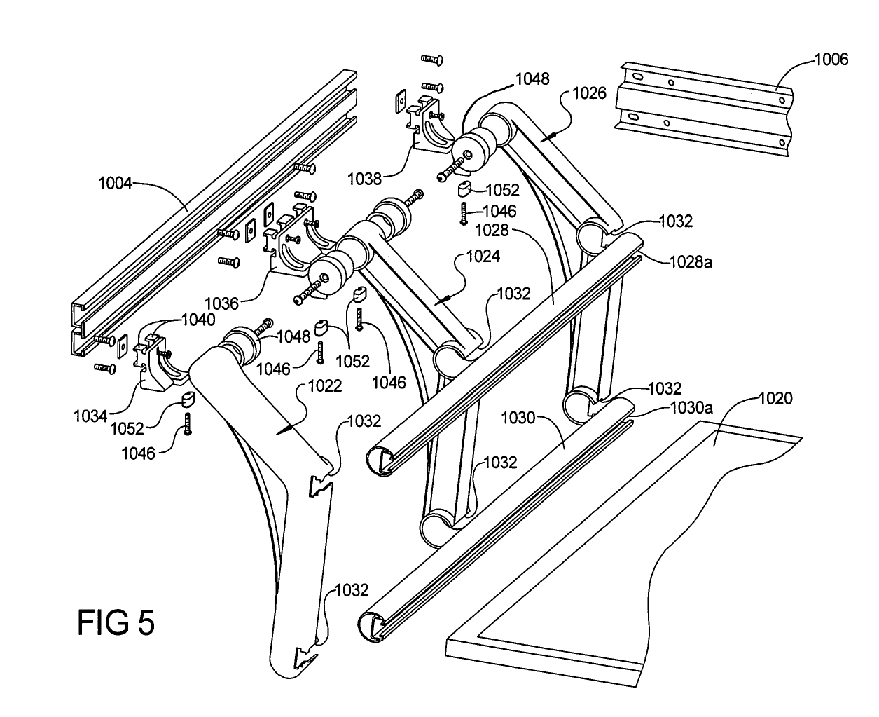

Referring to FIGS. 3 and 5, frame assembly 1016 will be described. Since frame assembly 1016 is identical in construction to frame assembly 1018, no additional description of the construction of frame assembly 1018 is required. Frame assembly 1016 includes a plurality of frame elements 1022, 1024 and 1026. The frame elements 1022-1026 are coupled together via an upper rail 1028 and a lower rail 1030. Each of the upper and lower rails 1028 and 1030 form a C-shaped track when viewed from one end, and thus each form a channel 1028a and 1030a, respectively (FIG. 5). The rails 1028 and 1030 are further identical in construction. Rails 1028 and 1030 can be used to support the planar support platform 1020 in either one of two positions above the floor of the truck bed 1002, those elevational positions being defined by channels 1028a and 1030a. The rails 1028 and 1030 are preferably extruded from aluminum but could be formed in any suitable manner and from other suitably strong materials. The frame elements 1016, 1018 may be formed from suitably high strength plastics, or even from aluminum or steel.

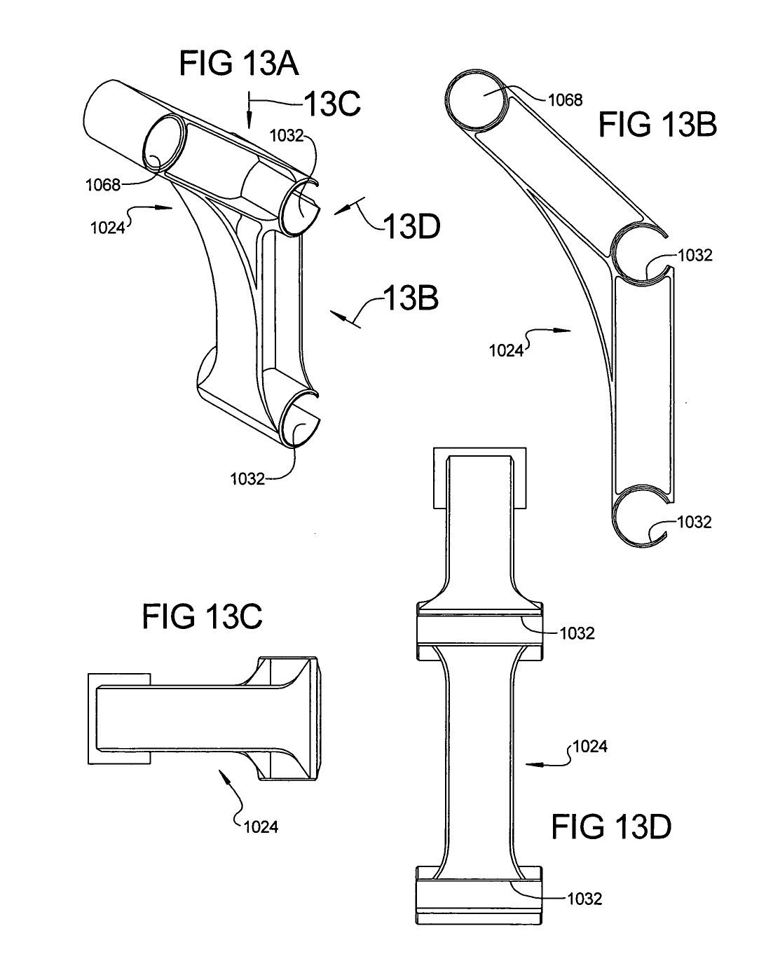

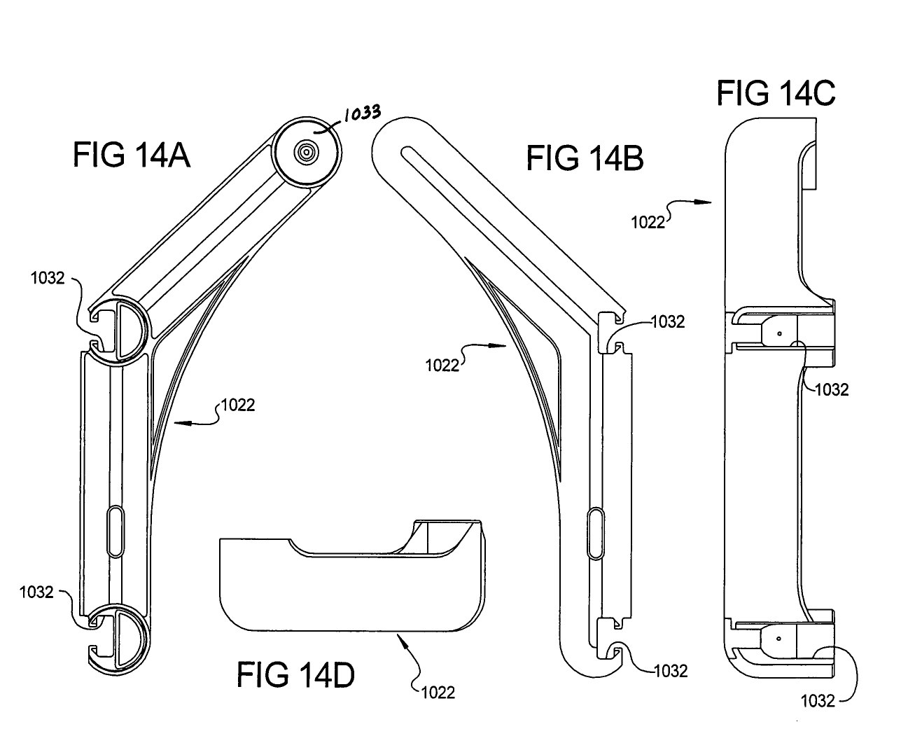

Referring to FIG. 5, each frame element 1022, 1024 and 1026 includes a semi-circular opening 1032 in which the rails 1028 and 1030 are slidably received and fixedly secured to so that the rails 1028 and 1030 cannot rotate or move linearly relative to the frame elements 1022-1026. FIGS. 13a-13d illustrate frame element 1024 in greater detail. FIGS. 14a-14d illustrate the frame element 1022 in greater detail. Frame element 1022 is identical in construction to frame element 1026.

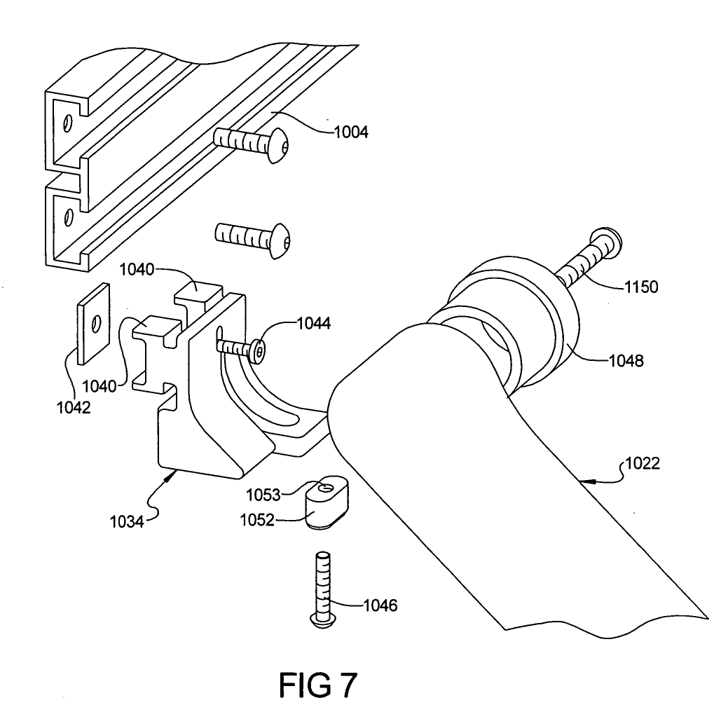

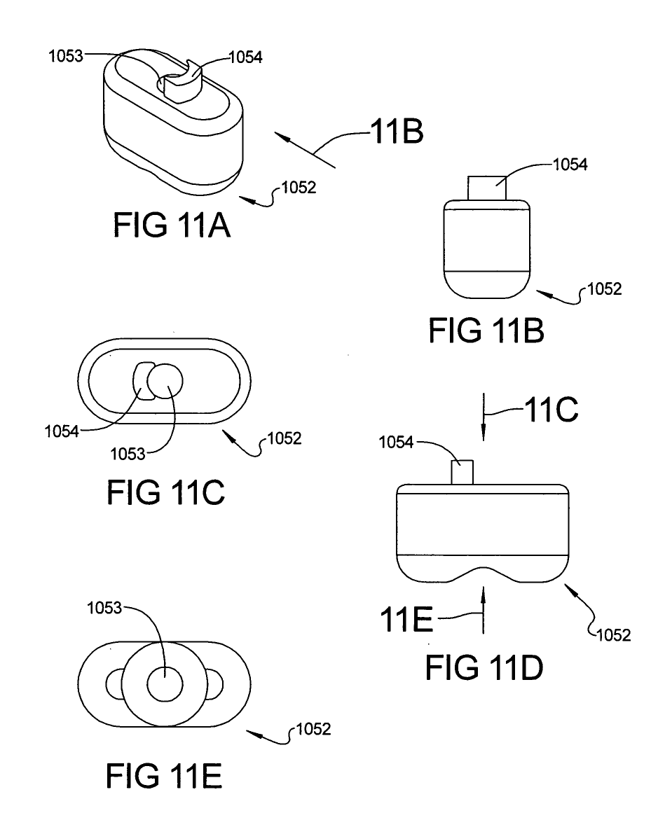

Referring further to FIGS. 5-7, each of the frame elements 1022, 1024 and 1026 are releasably supported by a support element 1034, 1036 and 1038, respectively. Support element 1034 is illustrated in enlarged fashion in FIG. 7 and includes T-lug portions 1040 which slide in the channel of the siderail 1004. A tap plate 1042 and threaded fastener 1044 are used to secure the support element 1034 at a desired position along the siderail 1004. Frame element 1022 is secured to the support element 1034 by a threaded fastener 1046 that extends through an end cap 1048. End cap 1048 is secured over a cup shaped recess 1033 (FIG. 14a) to the frame element 1022 by a threaded fastener 1050. A manually engageable release element 1052, also shown in FIGS. 11a-11e, receives the fastener 1046 through a bore 1053. Release element 1052, as best seen in FIGS. 11a-11e, includes a protruding shoulder 1054 which, in a first position, prevents removal of the frame element 1022 from the support element 1034, but in a second position rotated 90° from the first position, enables the frame element 1022 to be lifted off of the support element 1034 and thus completely detached from the support element 1034. Support elements 1034, 1036 and 1038 are preferably formed from high strength plastic, aluminum or any other suitably strong material.

With further reference to FIGS. 3 and 5, the first frame assembly 1016 can be secured to the sidewall 1010 by a suitable tie down strap 1056 or any other suitable component to prevent bouncing of rattling while the vehicle 1003 is moving. Preferably, whatever type of tie down mechanism is used is one that enables the user to quickly and easily disengage or detach the tie down mechanism to allow removal of the first frame assembly 1016 from the pickup truck bed 1002. Frame assembly 1018 is preferably held down in the same manner.

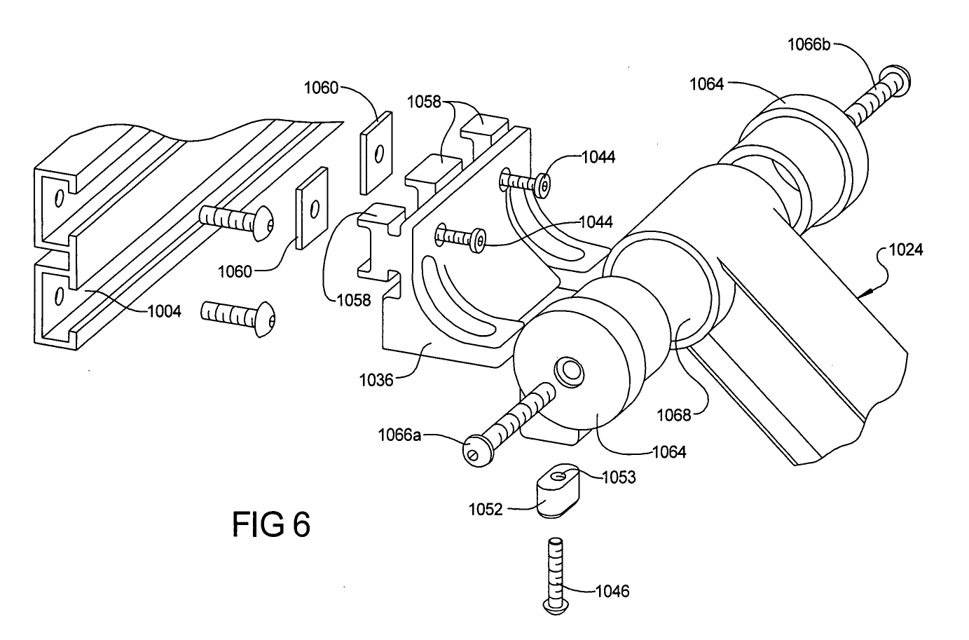

Referring to FIG. 6, frame element 1024 and its support element 1036 can be seen in greater detail. Support element 1036 similarly includes a plurality of T-lug portions 1058 which engage within the siderail 1004. Tap plates 1060 are secured by fastening elements 1044 and used to tighten the support element 1036 at a desired position along the siderail 1004.

Frame element 1024 includes a pair of end caps 1064 which are identical in construction, and which are each secured to the frame element 1024 by fasteners 1066a and 1066b. Faster 1066a may have a threaded shaft and fastener 1066b may have a threaded bore, which receives fastener 1066a. The end caps 1064 each fit within a circular opening 1068 at an end of the frame element 1024. One release element 1052 and one fastener 1046 are also used with each end cap 1064, as shown with FIG. 7, to retain the frame element 1024 to the support element 1036, or alternatively to enable it to be completely removed from the support element 1036.

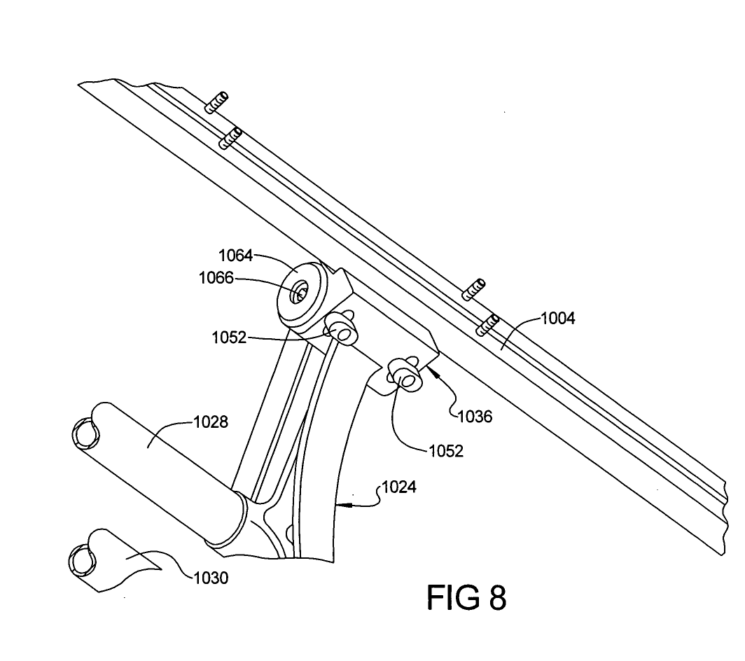

FIG. 8 illustrates the frame element 1024 from a bottom perspective showing the release elements 1052 in a locked position to prevent removal of the frame element 1024 from its support element 1036.

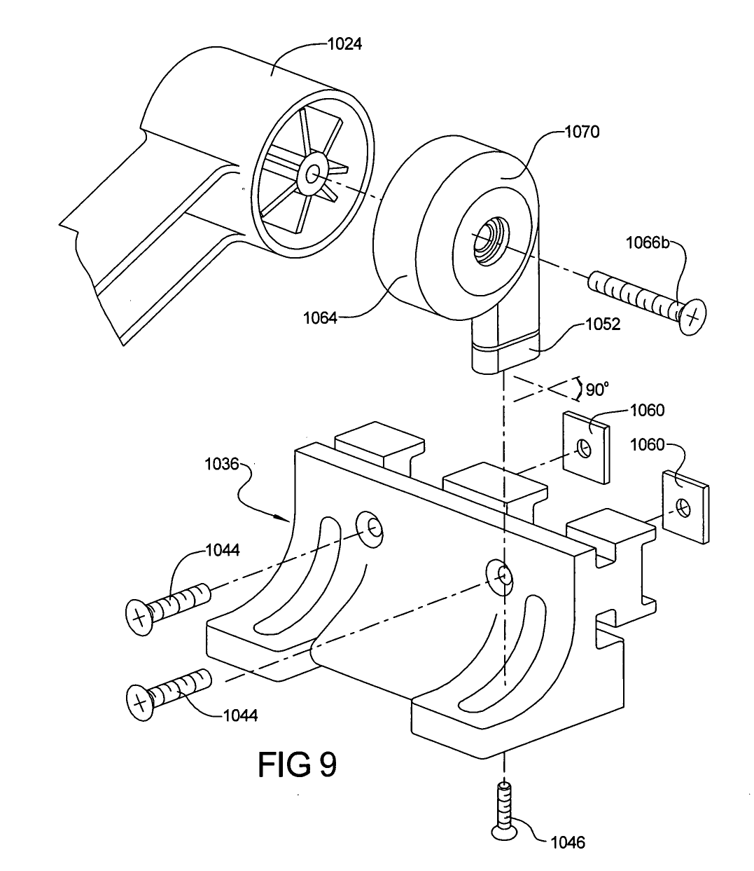

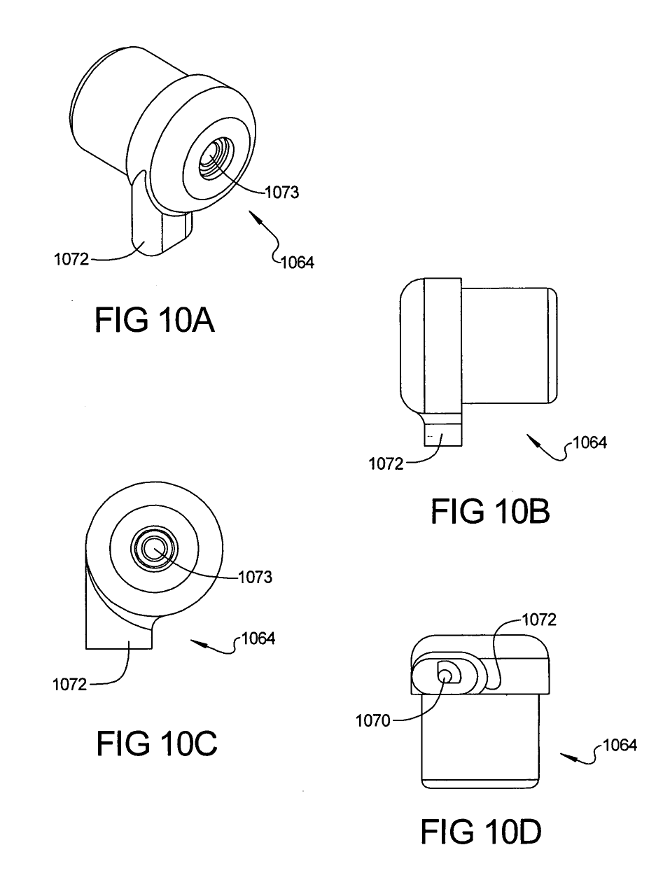

FIGS. 9 and 10a-10d illustrate the end cap 1064 in greater detail. In FIGS. 10a-10d, it can be seen that the end cap 1064 includes a blind threaded hole 1070 for receiving the fastener 1046 used to hold the release element 1052 to the neck portion 1072, while allowing the release element 1052 to be rotated. Neck portion 1072 provides a degree of clearance to enable one to grasp the release element 1052 and turn it 90° to thus lock and unlock the frame element 1024 from its associated support element 1036. Hole 1073 enables fastener 1066 to extend therethrough and to be secured to the other fastener 1066, to thus sandwich the frame element 1024 between the end caps 1064. It will be appreciated that the release elements 1052 associated with end caps 1048 are each secured to their respective end cap 1048 in an identical fashion. Thus, each of the frame elements 1022, 1024 and 1026 are able to rotate, relative to their respective support elements 1034, 1036 and 1038, and are also able to be detached when the need arises.

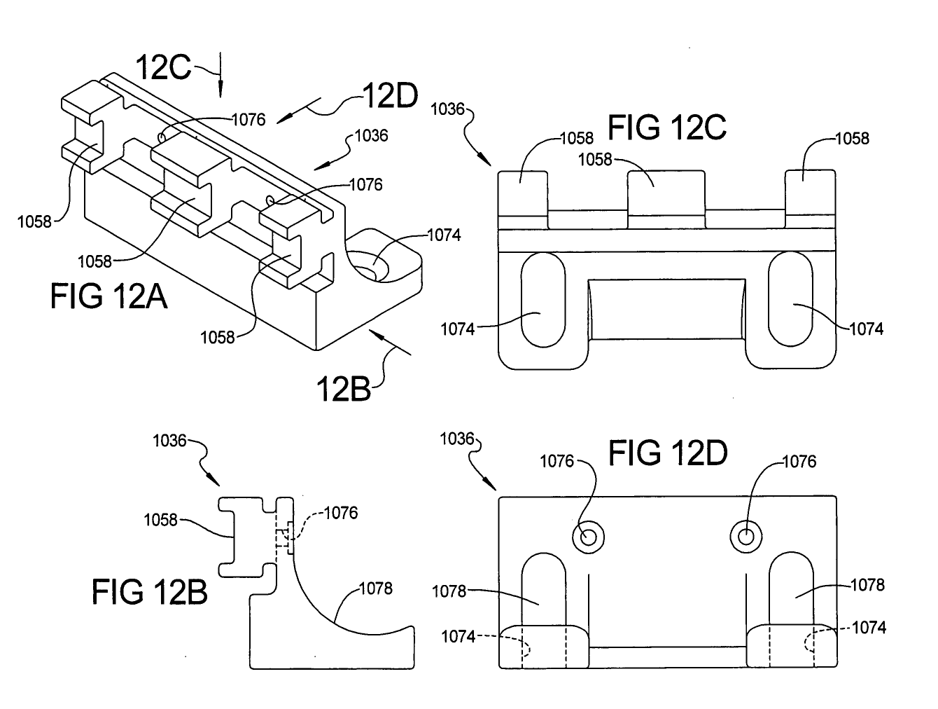

With brief reference to FIGS. 12a-12d, the support element 1036 is shown in greater detail. Support element 1036 includes openings 1074 for receiving fasteners 1046 (FIG. 6) therethrough. Openings 1076 enable threaded fasteners 1044 (FIG. 6) to extend through a wall portion of the support element 1036 and to engage the threaded openings in tap plates 1060 (FIG. 6). The support element 1036 also includes a pair of semi-circular wall portions 1078 for supporting the end caps 1064 and enabling rotational movement of the end caps 1064.

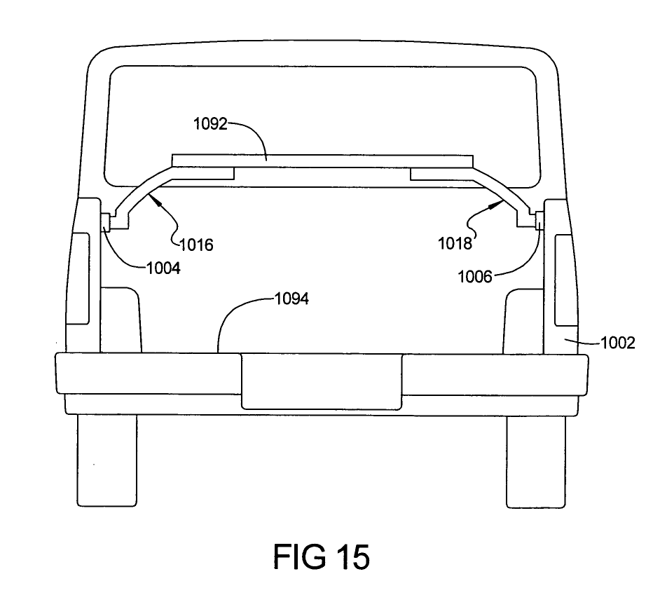

Referring to FIG. 15, an alternative preferred form of the cargo management system is illustrated. This embodiment makes use of the frame assemblies 1016 and 1018 when the two assemblies are positioned 90° upwardly from the position shown in FIG. 2. One or more cross members 1092 may be secured to each of the frame assemblies 1016 and 1018 to form an elevated platform on which articles may be supported above the upped edges of the siderails 1010, 1012, 1014 of the pickup truck bed 1002. It will be appreciated that minor modifications will need to be made to the ends of each of the frame assemblies 1016 and 1018 where they are secured to their respective support elements 1034, 1036 and 1038, to permit the 90° rotational movement of the assemblies 1016, 1018.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A cargo management system for a bed of a motor vehicle, wherein the bed has a floor and a pair of opposing sidewalls oriented generally perpendicular to the floor, the system comprising:
a pair of frame assemblies each being removably secured to a respective one of the opposing sidewalls to be positioned within the bed;
each said frame assembly operating to define at least compartment; and
a stowage bin removably supported within each said compartment.

2. The system of claim 1, wherein at least one of said stowage bins is removably supported within its associated said compartment.

3. The system of claim 1, wherein each of said frame assemblies is pivotally supported from its associated said sidewall.

4. A cargo management system for a bed of motor vehicle, wherein the bed has a floor and a pair of opposing sidewalls oriented generally perpendicular to the floor, the system comprising:
a frame assembly pivotally supported from one of the bed sidewalls and movable from a first position, wherein a portion of the frame assembly is positioned adjacent the floor of the bed, and a second position in which the frame assembly is positioned substantially above the bed;
the frame assembly operating to define at least one compartment; and
a removable stowage bin dimensioned to fit within the compartment and to be restrained within the compartment.

5. The system of claim 4, wherein the frame assembly defines a pair of compartments, and wherein the system includes a pair of stowage bins adapted to be removable supported within the pair of compartments.

6. The system of claim 4, wherein the system comprises a pair of said frame assemblies, one each of said frame assemblies being secured to opposing sidewalls of said bed.

7. The system of claim 6, further comprising a planar support element adapted to be supported by said frame assemblies when said frame assemblies are each disposed in said first position, such that said planar support element is supported closely adjacent said floor of said bed at a first elevation.

8. The system of claim 7, wherein said frame assemblies operate to support said planar support element at a second elevation above said first elevation to form a shelf extending above said floor of said bed for supporting cargo above said floor of said bed.

9. The system of claim 4, further comprising a side rail secured to one of said sidewalls of said bed, said frame assembly being supported from said side rail.

10. The system of claim 9, wherein said side rail comprises a channel; and
said system further comprises a plurality of support elements engaged at spaced apart locations within said channel of said side rail, for supporting said frame assembly for pivotal movement relative to said side rail.

11. The system of claim 10, wherein each said support element includes a release element for enabling said frame assembly to be released therefrom.

12. The cargo management system of claim 9, further comprising a pair of side rails secured to said side walls, each said side rail including a channel, and said frame assemblies being supported from respective ones of said side walls.

13. The cargo management system of claim 11, further comprising a plurality of support elements engaged with said channels of each of said side rails, each of said support elements interfacing a respective one of said frame assemblies to its respective said side rail.

14. The cargo management system of claim 12, wherein said support elements each comprise a release element for enabling its respective said side rail to be detached therefrom without the use of independent tools.

15. The cargo management system of claim 13, wherein each said frame element is pivotally supported from its respective said support element.

16. A cargo management system for a bed of a motor vehicle, wherein the bed includes a pair of opposing sidewalls each having a wheel well protruding therefrom, and a floor extending between the sidewalls, the system comprising:
a pair of frame assemblies each being removable secured to an associated one of said sidewalls to be disposed within said bed adjacent an associated one of said wheel wells;
each said frame assembly including support structure for supporting a planar panel at a position above said floor of said bed so that said planar panel forms a cargo supporting shelf above said floor of said bed; and
a stowage bin held by at least one of said frame assemblies.

17. The system of claim 16, wherein each of said frame assemblies forms a compartment, and each said compartment includes a stowage bin.

18. The system of claim 17, wherein each said stowage bin is removable from its associated said frame assembly.

19. The system of claim 16, wherein each said frame assembly includes an elongated rail, and wherein said planar panel is supported at edges thereof by said elongated rails.

20. A cargo management system for a bed of motor vehicle, wherein the bed has a floor and a pair of opposing sidewalls oriented generally perpendicular to the floor, the system comprising:
a pair of frame assemblies each pivotally supported from a respective one of the bed sidewalls, each said frame assembly being movable from a first position, wherein a portion thereof is positioned closely adjacent the floor of the bed, and a second position extending generally perpendicularly away from its respective said sidewall and substantially above the bed;
each said frame assembly operating to define at least one compartment; and
a planar support member dimensioned to approximate the dimensions of the floor of the bed, and supported by said frame assemblies at least closely adjacent said floor when said frame assemblies are in said first position, and forming a support shelf above said floor when said frame assemblies are in said second position.
